(19) United States
(12) Patent Application Publication
(10) Pub. No.: US 2007/0194688 A1
(43) Pub. Date: Aug. 23, 2007

(54) ELECTRON EMISSION DEVICE AND ELECTRON EMISSION DISPLAY USING THE SAME

(75) Inventors: Sang-Hyuck AHN, Suwon-si (KR); Sang-Jo Lee, Suwon-si (KR); Sang-Ho Jeon, Suwon-si (KR); Jin-Hui Cho, Suwon-si (KR); Byung-Gil Jea, Suwon-si (KR); Su-Bong Hong, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/676,681

(22) Filed: Feb. 20, 2007

(30) Foreign Application Priority Data
Feb. 20, 2006 (KR) 2006-16405

(51) Int. Cl. H01J 63/04; H01J 1/62

(52) U.S. Cl. 313/495; 313/497

(57) ABSTRACT

An electron emission device includes a substrate, first electrodes formed on the substrate, electron emission regions electrically connected to the first electrodes, and second electrodes placed over the first electrodes such that the second electrodes are insulated from the first electrodes, The second electrodes have a plurality of openings at the crossed areas of the first and the second electrodes to open the electron emission regions, wherein 1.36≦P/D≦1.65, where D indicates the width, or diameter, of the openings of the second electrodes, and P indicates the pitch of the openings of the second electrodes.

### CROSS-REFERENCE TO RELATED APPLICATIONS

This application claims priority to and the benefit of Korean Patent Application No. 2006-16405 filed in the Korean Intellectual Property Office on Feb. 20, 2006, the entire content of which is incorporated herein by reference.

### BACKGROUND OF THE INVENTION

1. Field of the Invention

Aspects of the invention relate to an electron emission device, and, in particular, to an electron emission device which has a gate electrode with an optimized opening pitch to width ratio, and to an electron emission display using the electron emission device.

2. Description of the Related Art

Generally, electron emission elements are classified, depending upon the kinds of electron sources, into a first type using a hot cathode, and into a second type using a cold cathode. Among the second type electron emission elements using a cold cathode are a field emission array (FEA) type, a surface-conduction emission (SCE) type, a metal-insulator-metal (MIM) type, and a metal-insulator-semiconductor (MIS) type.

The FEA-type electron emission element has electron emission regions, and has driving electrodes to control the emission of electrons from the electron emission regions. A cathode electrode and a gate electrode are provided as the driving electrodes. The electron emission regions are formed with a material having a low work function or a high aspect ratio, such as a carbonaceous material or a nanometer size material. The FEA-type electron emission element is based on the principle that where an electric field is applied to the electron emission regions under a vacuum atmosphere, electrons are easily emitted from the electron emission regions.

Arrays of the electron emission elements are formed on a first substrate to provide an electron emission device, and the electron emission device is assembled with a second substrate having a light emission unit based on phosphor layers, an anode electrode, etc., to construct an electron emission display. With the common FEA-type electron emission display, cathode electrodes, an insulating layer and gate electrodes are sequentially formed on the first substrate, and openings are formed at the gate electrodes and the insulating layer to partially expose the surfaces of the cathode electrodes. Electron emission regions are formed on the cathode electrodes within the openings. Phosphor layers and an anode electrode are formed on a surface of the second substrate facing the first substrate. The cathode and the gate electrodes are stripe-patterned, and cross each other. The crossed area of the two electrodes forms a pixel, and the electron emission regions are placed at a predetermined domain of the pixel such that they are spaced apart from each other.

Where predetermined driving voltages are applied to the cathode and the gate electrodes, electric fields are formed around the electron emission regions at the pixels where the voltage difference between the two electrodes exceeds a threshold value, and electrons are emitted from those electron emission regions. The emitted electrons are attracted by the high voltage applied to the anode electrode, and directed toward the second substrate, followed by colliding against the phosphors at the corresponding pixels and emitting light. With the above structure, the opening width of the gate electrode and the compactness of the gate electrode openings, that is, the opening pitch thereof, can influence the number of electron emission regions placed at the respective pixels, and the emission efficiency and process yield of the electron emission regions,

Considering the etching characteristic of the insulating layer and the processing of the electron emission regions, openings are typically formed at the gate electrode with an optimal size such that they are compactly and optimally arranged at a predetermined domain of the pixel. In this regard, the emission efficiency of the electron emission regions can be enhanced to realize a high luminance display screen, and the process yield can be heightened to increase productivity, promoting ease or formation of a high resolution device. However, with the conventional electron emission device, the opening pitch to width relation of the gate electrode is typically not optimized in the design and processing of the device so that these above-described effects are typically not optimized.

### SUMMARY OF THE INVENTION

Several aspects and embodiments of the invention provide an electron emission device to optimize the opening pitch to width relation of the gate electrode, to promote a heightening of the emission efficiency of the electron emission regions, increasing the process yield and realizing a high resolution display screen, and an electron emission display including the electron emission device.

In an exemplary embodiment of the invention, the electron emission device includes: a substrate, first electrodes formed on the substrate, electron emission regions electrically connected to the first electrodes, and second electrodes placed over the first electrodes, with the second electrodes being insulated from the first electrodes, with the second electrodes having a plurality of openings at the crossed areas of the first and the second electrodes to open the electron emission regions, wherein the ratio of the pitch of the openings of the second electrodes to the width, or diameter, of the openings of the second electrodes is in a range of 1.36≦P/D≦1.65, where D indicates the width of the openings of the second electrodes, and P indicates the pitch of the openings of the second electrodes,

According to aspects of the invention, the electron emission region and the opening of the second electrode can be formed in the shape of a circle. Also, the openings of the second electrode can be serially arranged in the longitudinal direction of one of the first and the second electrodes.

According to further aspects of the invention, the electron emission device can further include a third electrode placed over the second electrodes, wherein the third electrode is insulated from the second electrodes. The third electrode can have openings at the respective crossed areas of the first and the second electrodes to simultaneously open the openings of the second electrodes at each crossed area. Also, one of the first and the second electrodes can be a scan electrode, and the other of the first and second electrodes can be a data electrode, and the third electrode can be a focusing electrode.

In another exemplary embodiment of the invention, the electron emission display includes: a first substrate; a second substrates, with the first substrate being positioned in facing relation to the second substrate; first electrodes formed on the first substrate, electron emission regions electrically connected to the first electrodes, and second electrodes placed over the first electrodes, with the second electrodes being insulated from the first electrodes, with the second electrodes having a plurality of openings at the crossed areas of the first and the second electrodes to open the electron emission regions, phosphor layers being formed on a surface of the second substrate, and an anode electrode being placed on a surface of the phosphor layers, wherein the ratio of the pitch of the openings of the second electrodes to the width, or diameter, of the openings of the second electrodes is in the range of 1.36≦P/D≦1.65, where D indicates the width of the openings of the second electrodes, and P indicates the pitch of the openings of the second electrodes.

Further, according to aspects of the invention, the phosphor layers can include red, green and blue phosphor layers alternately arranged in a direction of the second substrate, and the openings of the second electrodes can be serially arranged at the center of the crossed area in a direction perpendicular to the direction of the second substrate.

Additional aspects and/or advantages of the invention are set forth in the description which follows or are evident from the description, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partial exploded perspective view of an electron emission display according to an exemplary embodiment of the invention;

FIG. 2 is a partial sectional view of the electron emission display of FIG. 1;

FIG. 3 is a partial amplified plan view of the electron emission device shown in FIG. 1;

FIG. 4 is a graph illustrating the variation in the discharge current as function of the opening pitch to width ratio of the gate electrode with the electron emission display of FIG. 1 according to the invention;

FIG. 5 is a partial exploded perspective view of an electron emission display according to another exemplary embodiment of the present invention; and

FIG. 6 is a partial amplified plan view of the electron emission device shown in FIG. 5.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures, with well-known functions or constructions not necessarily being described in detail.

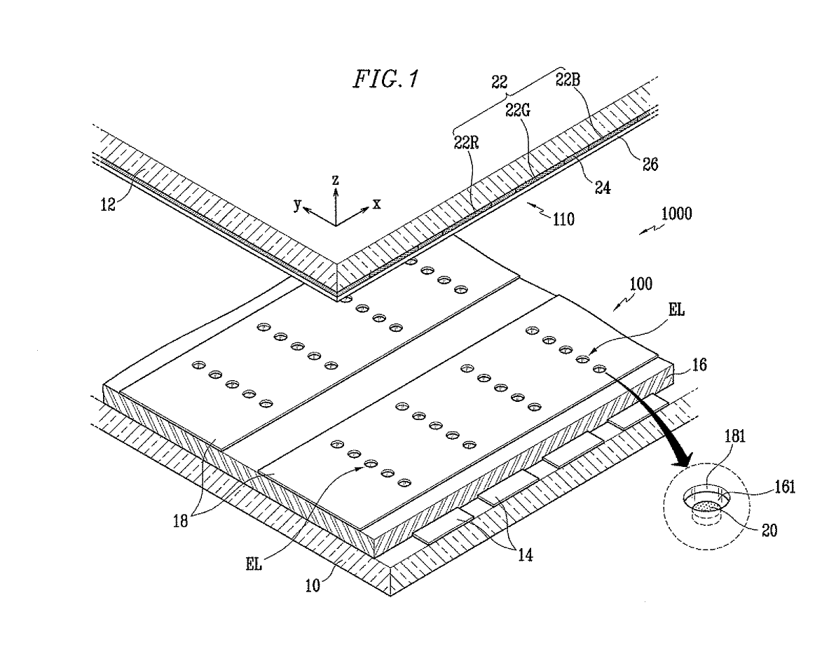

In FIGS. 1 to 3, an electron emission display 1000 and an electron emission device 100 according to an exemplary embodiment of the invention are illustrated. The electron emission display 1000 includes first and second substrates 10 and 12, respectively, positioned in facing relation to each other in parallel, and spaced from each other by a predetermined distance H. A sealing member (not shown) is provided at the peripheries of the first and the second substrates 10 and 12 to seal them, and the internal space between the two substrates 10 and 12 is evacuated, such as to be at 10⁻⁶ Torr, to provide a vacuum vessel with the first and the second substrates 10 and 12 and the sealing member.

Electron emission elements EL are formed on a surface of the first substrate 10, facing the second substrate 12 while forming arrays, to construct the electron emission device 100 with the first substrate 10. The electron emission device 100 provides the electron emission display 1000 in association with the second substrate 12, and a light emission unit 110 provided at the second substrate 12.

Cathode electrodes 14 are stripe-patterned on the first substrate 10 in a direction of the first substrate 10 as first electrodes, and an insulating layer 16 is formed on typically the entire surface of the first substrate 10 and covers the cathode electrodes 14. Gate electrodes 18 are stripe-patterned on the insulating layer 16 perpendicular to the cathode electrodes 14 as second electrodes.

Where the crossed areas of the cathode and the gate electrodes 14 and 18, respectively, are defined as pixels, electron emission regions 20 are formed on the cathode electrodes 14 at the respective pixels. Openings 161 and 181 are formed at the insulating layer 16 and the gate electrodes 18 corresponding to the respective electron emission regions 20 to expose the electron emission regions 20 on the first substrate 10. The electron emission regions 20 are typically formed with a material emitting electrons in response to an electric field is applied thereto under a vacuum atmosphere, such as a carbonaceous material or a nanometer (nm) size material, or other suitable material.

By way of example, the electron emission regions 20 can be formed with carbon nanotube, graphite, graphite nanofiber, diamond, diamond-like carbon, fullerene C₆₀, silicon nanowire, or a combination thereof. The formation of the electron emission regions 20 can be by screen printing, direct growth, chemical vapor deposition, sputtering, or other suitable operation.

In the electron emission display 1000 and the associated electron emission device 100 of FIGS. 1 to 3, the electron emission regions 20 are typically serially arranged at the respective pixels in the longitudinal direction of any one of the cathode and the gate electrodes 14 and 18, as for example, in the direction of the cathode electrode 14, and the respective electron emission regions 20 and the openings 181 of the gate electrodes 18 can be formed in the shape of a circle, or other suitable shape or configuration.

Phosphor layers 22 with red, green and blue phosphor layers 22R, 22G and 22B are formed on a surface of the second substrate 12 facing the first substrate 10 such that the phosphor layers 22R, 22G and 22B are spaced apart from each other, and a black layer 24 is formed between the respective phosphor layers 22R, 22G and 22B to enhance the screen contrast. The phosphor layers 22 are arranged in the electron emission display 1000 such that one of the three-colored phosphor layers 22R, 22G and 22B corresponds to a respective crossed area of the cathode and the gate electrodes 14 and 18,

An anode electrode 26 is formed on the phosphor and the black layers 22 and 24 with a metallic material such as aluminum (Al) or other suitable material. The anode electrode 26 receives a high voltage required to accelerate electron beams to place the phosphor layers 22 in a high potential state, and to reflect the visible rays radiated from the phosphor layers 22 to the first substrate 10 toward the second substrate 12 to heighten the screen luminance.

Also, the anode electrode 26 can be formed with a transparent conductive material such as indium tin oxide (ITO) or other suitable material. Where the anode electrode 26 is formed with a transparent conductive material, the anode electrode 26 is placed on a surface of the phosphor and the black layers 22 and 24 directed toward the second substrate 12. Further, according to aspects of the invention, the metallic layer and the transparent conductive layer can be simultaneously formed to function as the anode electrode 26.

As shown in FIG. 2, spacers 28 are arranged between the first and the second substrates 10 and 12 to substantially maintain the space between the first and second substrates 10 and 12, under the pressure applied to the vacuum vessel, formed by the first and second substrates 10 and 12 and the sealing member, and substantially maintain the predetermined distance H between the two substrates 10 and 12. The spacer 28 is typically positioned at the area of the black layer 24, where the spacer 28 does not intrude upon the area of the phosphor layers 22.

With the electron emission display 1000, predetermined voltages are applied to the cathode electrodes 14, the gate electrodes 18 and the anode electrode 26 from the outside of the electron emission display 1000. For example, one of the cathode and the gate electrodes 14 and 18 receives a scan driving voltage to function as a scan electrode, and the other of the cathode and the gate electrodes 14 and 18 receives a data driving voltage to function as a data electrode. The anode electrode 26 typically receives a positive direct current voltage of several hundred to several thousand volts required to accelerate the electron beams.

In the electron emission display 1000, an electric field is formed around the electron emission regions 20 at the pixels where the voltage difference between the cathode and the gate electrodes 14 and 18 exceeds a threshold value, and electrons are emitted from the electron emission regions 20. The emitted electrons are attracted by the high voltage applied to the anode electrode 26, and collide against the phosphor layers 22 at the corresponding pixels to emit light.

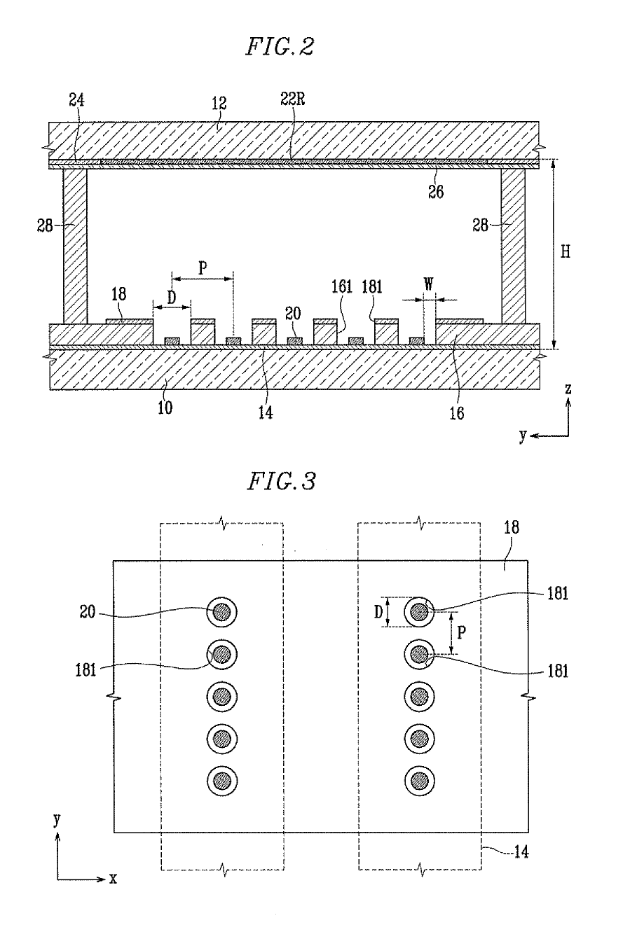

With the electron emission display 1000 and the electron emission device 100, the width D of the opening 181 of the gate electrode 18, such as the diameter D of the opening 181 illustrated in FIG. 3, is optimized depending upon the processing characteristics, such as the etching characteristic of the insulating layer 16 and the processing of the electron emission regions 20. While the width D corresponds to the diameter D of the generally circular shaped opening 181 in the exemplary embodiment of FIGS. 1 through 3, the width D of the openings of the gate electrode is not limited in this regard, and the width D can correspond to the width of other suitable shaped openings of the gate electrode, according to aspects of the invention, Where the openings 181 are formed at the insulating layer 16 through wet etching, the isotropic etching characteristic of the wet etching should be considered, and the marginal width W, as shown in FIG. 2, around the electron emission regions 20 should be controlled, depending upon the processing of the electron emission regions 20.

According to aspects of the invention, the area of the electron emission regions 20 within the pixel is limited to a predetermined domain at the center of the pixel, In this regard, where the electrons emitted from the electron emission regions 20 are diffused at a predetermined diffusion angle, the electron beam spot on the second substrate 12 can be prevented from being enlarged up to the neighboring phosphor layers 22, and the electrons typically do not collide against the spacers 28, thereby promoting prevention of the surface of the spacers 28 from being charged.

With the electron emission display and electron emission device according to aspects of the invention, such as the exemplary embodiment of the electron emission display 1000 and the electron emission device 100, the ratio of the pitch P, such as the eccentric distance between the openings, of the openings 181 of the gate electrode 18 to the width, or diameter D, of the openings 181 is optimized so that the emission efficiency of the electron emission regions 20 is heightened, and prevention of a possible process failure is promoted. Further, according to aspects of the invention, in the electron emission display and the electron emission device, the gate electrode, such as the gate electrode 18, is structured according to Equation (1) wherein the ratio of the pitch of the openings 181 to the width, or diameter, of the openings 181 of the gate electrodes 18 is in a range of:

1.36≦P/D≦1.65 (1),

where D indicates the diameter of the opening 181 of the gate electrode 18 and P indicates the pitch of the openings 181 of the gate electrode 18. Also, it is understood that, according to aspects of the invention, the ratio of P/D in Equation (1) can be substantially in the range of from about 1.36 to about 1.65.

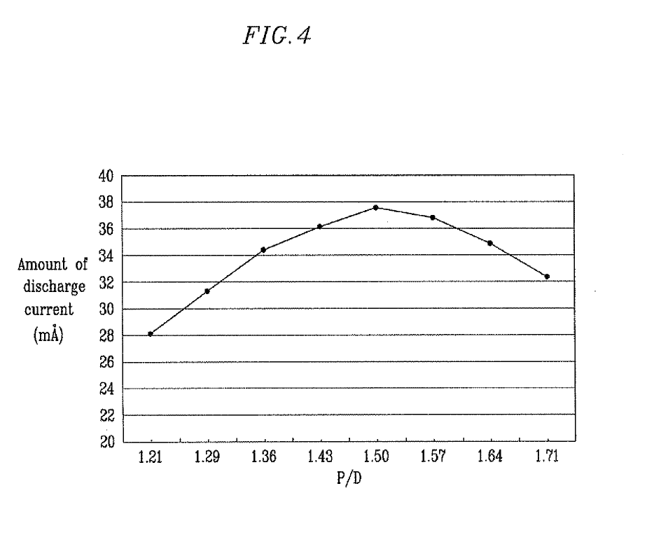

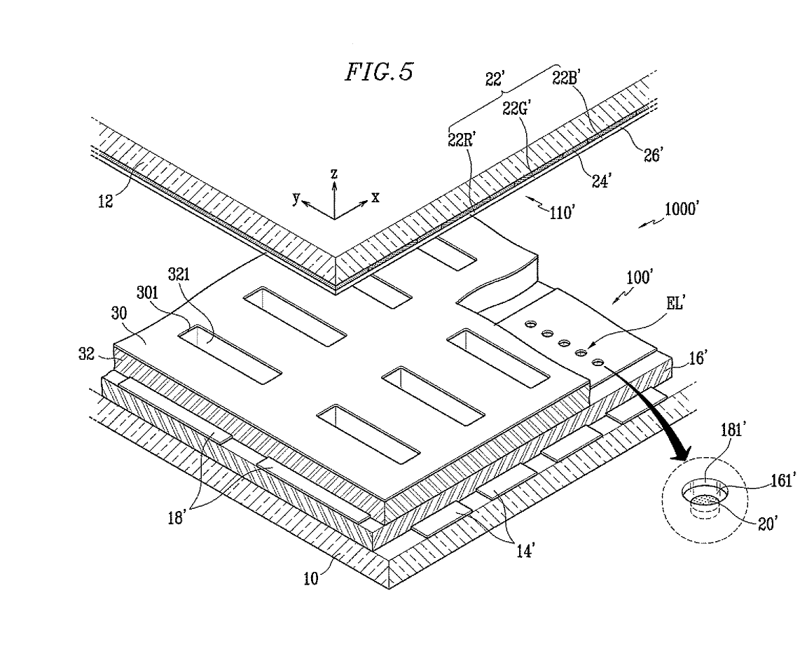

FIG. 4 is a graph illustrating the amount of discharge current of the electron emission regions at a pixel measured while varying the opening pitch P to diameter D ratio of the gate electrode. In the experiments, the thickness of the insulating layer 16 was 3 μm, and the diameter D of the opening 181 of the gate electrode 18 was 14 μm. The amount of discharge current of the electron emission regions 20 was measured while varying the pitch P of the openings 181 from 17 μm to 24 μm. With the driving conditions, the cathode voltage was established to be 0V, the gate voltage to be 60V, and the anode voltage to be 8 kV.

As shown in FIG. 4, where the opening pitch to diameter ratio P/D was 1.5, the amount of the discharge current was the largest. Where the opening pitch to diameter ratio P/D was in the range of 1.36-1.65, the discharge current was 90% or more of the peak value of the discharge current.

Where the opening pitch to diameter ratio P/D is less than 1.36, the emission efficiency of the electron emission regions 20 can deteriorate in that the gate electrode openings 181 are not necessarily spaced apart from each other with a distance so that the electric field of the gate electrode 18 surrounding one of the electron emission regions 20 is substantially offset by the neighboring openings 181. By contrast, where the opening pitch to diameter ratio P/D exceeds 1.65, the number of electron emission regions 20 can be reduced so that the amount of the discharge current substantially decreases.

Also, where the opening pitch to diameter ratio PID of the gate electrode, such as the gate electrode 18 is in the range of 1.41 to 1.60, the amount of discharge current is typically 95% or more of the peak value of the discharge current. Therefore, according to aspects of the invention, in the electron emission display, the gate electrode, such as the gate electrode 18, is further structured according to Equation (2) wherein the ratio of the pitch of the openings 181 to the width, or diameter, of the openings 181 of the gate electrode 18 is further in the range of:

1.41≦P/D≦1.60 (2)

### Also, it is understood that, according to aspects of the invention, the ratio of P/D in Equation (2) can be substantially in the range of from about 1.41 to about 1.60.

Moreover, where the opening pitch to diameter ratio P/D is typically less than 1.36, the openings 181 and 161 of the gate electrodes 18 and the insulating layer 16 are not necessarily formed uniformly, and the etching margin can be reduced so that the openings 181 of the gate electrodes 18 can be connected to each other, or the openings 161 of the insulating layer 16 can be connected to each other, and process failures can result. However, where the gate electrode of the electron emission display or the electrode emission device, such as the gate electrode 18, is structured according to the aspects of the invention, as described, the amount of the discharge current can be maximized to reach a relatively large value with the same, or substantially the same, gate voltage, and also process failures can be minimized.

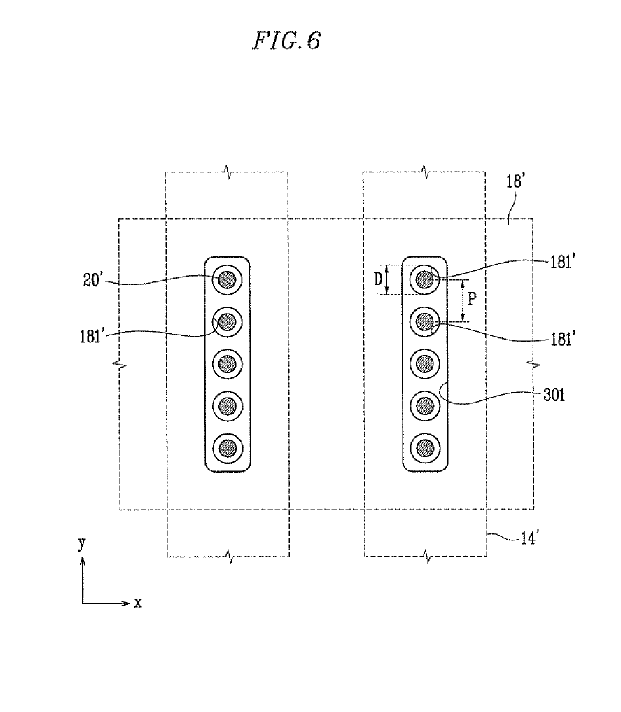

Referring to FIGS. 5 and 6, an electron emission display 1000′ and an electron emission device 100′ according to another exemplary embodiment of the invention is illustrated. The electron emission display 1000′ includes first and second substrates 10 and 12, respectively, positioned in facing relation to each other in parallel, and spaced from each other by a predetermined distance. A sealing member (not shown) is provided at the peripheries of the first and the second substrates 10 and 12 to seal them, and the internal space between the two substrates 10 and 12 is evacuated, such as to 10⁻⁶ Torr, to provide a vacuum vessel with the first and the second substrates 10 and 12 and the sealing member.

Electron emission elements EU are formed on a surface of the first substrate 10, facing the second substrate 12 while forming arrays, to construct or form the electron emission device 100′ with the first substrate 10. The electron emission device 100′ provides the electron emission display 1000′ in association with the second substrate 12, and a light emission unit 110′ is provided at the second substrate 12.

Cathode electrodes 14′ are stripe-patterned on the first substrate 10 in a direction of the first substrate 10 as first electrodes, and an insulating layer 16′ is formed typically on the entire surface of the first substrate 10 and covers the cathode electrodes 14′. Gate electrodes 18′ are stripe-patterned on the insulating layer 16′ perpendicular to the cathode electrodes 14′ as second electrodes.

Where the crossed areas of the cathode and the gate electrodes 14′ and 18′, respectively, are defined as pixels, electron emission regions 20′ are formed on the cathode electrodes 14′ at the respective pixels. Openings 161′ and 181′ are formed at the insulating layer 16′ and the gate electrodes 18′ corresponding to the respective electron emission regions 20′ to expose the electron emission regions 20′ on the first substrate 10. The electron emission regions 20′ are typically formed with a material emitting electrons where an electric field is applied thereto under a vacuum atmosphere, such as a carbonaceous material or a nanometer (nm) size material, or other suitable material.

As shown in FIGS. 5 and 6, the electron emission device 100′ and the electron emission display 1000′, according to another exemplary embodiment of the invention, further includes a focusing electrode 30 placed or positioned over the gate electrodes 18′. Where the insulating layer disposed between the cathode electrodes 14′ and the gate electrodes 18′ is referred to as a first insulating layer 16′, a second insulating layer 32 is placed at the entire area of the first substrate 10 over the gate electrodes 18′, and a focusing electrode 30 is formed on the second insulating layer 32.

Openings 301 and 321 are formed at the focusing electrode 30 and the second insulating layer 32 to pass the electron beams. The openings 301 and 321 are formed at the respective pixels one by one to simultaneously open the electron emission regions 20′ and the gate electrode openings 181′ at each pixel. The focusing electrode 30 typically receives a negative direct current voltage of several volts to several tens of volts, with the negative direct current voltage received by the focusing electrode 30 being of a suitable amount to provide a repulsive force to the electrons passing the openings 301 to focus the electrons on the center of the corresponding bundle of the electron beams.

Where the openings 301 are formed at the focusing electrode 30 to simultaneously open the gate electrode openings 181′, the focusing electrode 30 typically does not influence, or does not substantially influence, the diameter D and pitch P of the gate electrode openings 181′. For this reason, in the exemplary embodiment of electron emission device 100′ or the electron emission display 1000′ of FIGS. 5 and 6, the ratio P/D of the pitch of the openings 181′ of the gate electrode 18′ to the width, or diameter, of the openings 181′ of the gate electrode 18′ is therefore established to be the same or corresponding to the exemplary embodiments of the electron emission device 100 or the electron emission display 1000 of FIGS. 1 to 3, in accordance with the aspects of the invention previously described and discussed in relation to Equations (1) and/or (2) in this regard.

Therefore, in that the focusing electrode 30 typically serves to focus the electron beams during the device operation, where the driving voltage, the thickness of the first insulating layer 16′, and the width, or diameter, and pitch of the openings 181′ of the gate electrode 18′ in the electron emission device 100′ or the electron emission display 1000′ of FIGS. 5 and 6 are established to be the same as or corresponding to those of the electron emission device 100 or the electron emission display 1000 of the previously described exemplary embodiment of FIGS. 1 to 3, the amount of discharge current of the electron emission regions 20′ is substantially the same as that illustrated in the graph of FIG. 4. Thus, in the electron emission device 100′ and the electron emission display 1000′, according to aspects of the invention, where the gate electrode 18′ is structured according to relationships of Equations (1) and/or (2) and/or other aspects of the invention, the amount of the discharge current can be maximized to reach a relatively large value with the same, or substantially the same, gate voltage, and process failures can be minimized,

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. An electron emission device, comprising:
a substrate;
first electrodes formed on the substrate;
electron emission regions respectively electrically connected to the first electrodes; and
second electrodes respectively positioned over the first electrodes, wherein
the second electrodes are insulated from the first electrodes,
the second electrodes include a plurality of openings at crossed areas, where the second electrodes respectively cross over the first electrodes, to open the electron emission regions, and wherein a ratio of a pitch of the openings of the second electrodes to a width of the openings of second electrodes is in a range of: 1.36≦P/D≦1.65, where D is the width of the openings of the second electrodes and P is the pitch of the openings of the second electrodes.

2. The electron emission device of claim 1, wherein:
the ratio of the pitch of the openings of the second electrodes to the width of the openings of the second electrodes is further in a range of: 1.41≦P/D≦1.60.

3. The electron emission device of claim 1, wherein:
the electron emission regions and the openings of the second electrodes are formed in the shape of a circle.

4. The electron emission device of claim 1, wherein:
the openings of the second electrodes are respectively positioned at the center of the crossed areas, where the second electrodes cross over the first electrodes.

5. The electron emission device of claim 4, wherein:
the openings of the second electrodes are serially arranged in the longitudinal direction of the first electrodes or the second electrodes.

6. The electron emission device of claim 1, further comprising:
a third electrode positioned over the second electrodes, wherein the third electrode is insulated from the second electrodes.

7. The electron emission device of claim 6, wherein:
the third electrode includes a plurality of openings positioned at the respective crossed areas, where the second electrodes cross over the first electrodes, to open the openings of the second electrodes at the crossed areas.

8. The electron emission device of claim 6, wherein:
the first electrodes comprise scan electrodes or data electrodes,
the second electrodes comprise scan electrodes when the first electrodes comprise data electrodes, and the second electrodes comprise data electrodes when the first electrodes comprise scan electrodes, and
the third electrode comprises a focusing electrode.

9. The electron emission device of claim 1, wherein:
the electron emission regions comprise at least one material selected from the group consisting of carbon nanotube, graphite, graphite nanofiber, diamond, diamond-like carbon, fullerene C₆₀ and silicon nanowire.

10. An electron emission display, comprising:
a first substrate;
a second substrate positioned in facing relation to the first substrate;
first electrodes formed on the first substrate;
electron emission regions respectively electrically connected to the first electrodes;
second electrodes respectively positioned over the first electrodes, wherein
the second electrodes are insulated from the first electrodes,
the second electrodes include a plurality of openings at crossed areas, where the second electrodes respectively cross over the first electrodes, to open the electron emission regions, and
wherein a ratio of a pitch of the openings of the second electrodes to a width of the openings of the second electrodes is in a range of 1.36≦P/D≦1.65, where D is the width of the openings of the second electrodes and P is the pitch of the openings of the second electrodes;
phosphor layers formed on a surface of the second substrate; and
an anode electrode positioned on a surface of the phosphor layers.

11. The electron emission display of claim 105 wherein the ratio of the pitch of the openings of the second electrodes to the width of the openings of the second electrodes is further in a range of: 1.41≦P/D≦1.60.

12. The electron emission display of claim 10, wherein:
the electron emission regions and the openings of the second electrodes are formed in the shape of a circle.

13. The electron emission display of claim 12, wherein:
the openings of the second electrodes are respectively positioned at the center of the crossed areas, where the second electrodes cross over the first electrodes.

14. The electron emission display of claim 10, wherein:
the phosphor layers comprise red, green and blue phosphor layers alternately arranged in a direction of the second substrate, and
the openings of the second electrodes are serially arranged at the center of the crossed areas, where the second electrodes cross over the first electrodes, in a direction perpendicular to the direction of the second substrate.

15. The electron emission display of claim 10, further comprising:
a third electrode positioned over the second electrodes, wherein
the third electrode is insulated from the second electrodes, and
the third electrode includes a plurality of openings respectively positioned at the crossed areas, where the second electrodes cross over the first electrodes, to open the openings of the second electrodes.

16. The electron emission display of claim 15, wherein:
the first electrodes comprise scan electrodes or data electrodes,
the second electrodes comprise scan electrodes when the first electrodes comprise data electrodes, and the second electrodes comprise data electrodes when the first electrodes comprise scan electrodes, and
the third electrode comprises a focusing electrode.

17. The electron emission display of claim 10, wherein:
the electron emission regions are formed of a carbonaceous material or a nanometer (nm) size material.

18. The electron emission display of claim 10, wherein:
the phosphor layers are arranged in the electron emission display such that the phosphor layers respectively correspond to the crossed areas, where the second electrodes respectively cross over the first electrodes.

19. The electron emission display of claim 101 wherein:
an area of the electron emission regions within a pixel is limited to a predetermined domain at a center of the pixel.

20. The electron emission device of claim 1, wherein:
the electron emission regions are formed of a carbonaceous material or a nanometer (nm) size material.

21. An electron emission display, comprising;
a first substrate;
a second substrate positioned in facing relation to the first substrate;
first electrodes formed on the first substrate;
electron emission regions respectively electrically connected to the first electrodes;
second electrodes respectively positioned over the first electrodes, wherein
the second electrodes are insulated from the first electrodes,
the second electrodes include a plurality of openings at crossed areas, where the second electrodes respectively cross over the first electrodes, to open the electron emission regions, and
wherein a ratio P/D of a pitch of the openings of the second electrodes to a width of the openings of the second electrodes is substantially in a range of from about 1.36 to about 1.65, where D is the width of the openings of the second electrodes and P is the pitch of the openings of the second electrodes;
a plurality of phosphor layers formed on a surface of the second substrate; and
an anode electrode positioned on a surface of the phosphor layers.

22. The electron emission display of claim 21, further comprising:
a third electrode positioned over the second electrodes, wherein
the third electrode is insulated from the second electrodes, and
the third electrode includes a plurality of openings respectively positioned at the crossed areas, where the second electrodes cross over the first electrodes, to open the openings of the second electrodes.

23. An electron emission device, comprising:
a substrate;
first electrodes formed on the substrate;
electron emission regions electrically connected to the first electrodes; and
second electrodes respectively positioned over the first electrodes, wherein
the second electrodes are insulated from the first electrodes,
the second electrodes include a plurality of openings at crossed areas, where the second electrodes respectively cross over the first electrodes, to open the electron emission regions, and
wherein a ratio P/D of a pitch of the openings of the second electrodes to a width of the openings of the second electrodes is substantially in a range of from about 1.36 to about 1.65, where D is the width of the openings of the second electrodes and P is the pitch of the openings of the second electrodes.

24. The electron emission device of claim 23, further comprising:
a third electrode positioned over the second electrodes, wherein the third electrode is insulated from the second electrodes.

25. The electron emission device of claim 24, wherein:
the third electrode includes a plurality of openings positioned at the respective crossed areas, where the second electrodes cross over the first electrodes, to open the openings of the second electrodes at the crossed areas.
